(19) United States
(12) Patent Application Publication
(10) Pub. No.: US 2014/0260851 A1
(43) Pub. Date: Sep. 18, 2014

(54) FLEXIBLE DIE RETAINING SYSTEM AND METHOD

(71) Applicant: WALLACE J. BEAUDRY, ELKHART LAKE, WI (US)

(72) Inventor: WALLACE J. BEAUDRY, ELKHART LAKE, WI (US)

(21) Appl. No.: 14/209,707

(22) Filed: Mar. 13, 2014

Related U.S. Application Data
(60) Provisional application No. 61/780,051, filed on Mar. 13, 2013.

(51) Int. Cl. B26D 1/36; B26D 7/26

(52) U.S. Cl. CPC B26D 1/365; B26D 7/2614
USPC 83/56; 83/346

(57) ABSTRACT

A method and apparatus for producing shaped articles from a web material is disclosed. The apparatus generally includes a rotary cylinder adapted to receive a flexible cutting die, and an anvil roller operating in cooperating rotational movement with the rotary cylinder. The cylinder includes attachment mechanisms that are adapted to be received by apertures in the flexible cutting die to thereby secure the cutting die to the cylinder. The apparatus die cuts web material into predetermined shapes.

### RELATED APPLICATION

This application claims the benefit of co-pending U.S. Provisional Patent Application Ser. No. 61/780,051, filed 13 Mar. 2013, and entitled “Flexible Die Retaining System and Method.”

### BACKGROUND OF THE INVENTION

Presently, flexible dies for use in the print industry or die cutting industry may be retained on cylinders. The die retaining cylinders are typically made of heavy steel and include a plurality of magnets located about the cylinder circumferential surface. In use, a steel flexible die is secured to the cylinder by use of the magnets. While efficient in retaining the die, this standard means of attaching a flexible die to a cylinder has several shortcomings. For example, a flexible die must be carefully aligned on the cylinder prior to use. Therefore, the user must accurately align the flexible die about the cylinder circumferential surface as it is attracted to the magnetic surface during installation on the cylinder. This procedure takes time. Further, if the flexible die is initially installed in a misaligned position it must be reset prior to use since alignment is critical to achieve accurate print or cut results. Alignment and realignment takes time and can slow production times. Further, the cost of typical fully magnetized cylinders can be significant, with a separate cylinder required for each flexible die width. A user requiring multiple flexible dies having varying widths is therefore forced to invest in multiple costly cylinders or to retool dies to fit a single cylinder.

The present invention provides a less costly, more user friendly alternative to known flexible die retaining systems by providing a system that is able to accept dies of varying widths, allows facile flexible die alignment on the cylinder, and is less costly to manufacture as compared to known flexible die systems.

### SUMMARY OF THE INVENTION

The present invention relates to a method and an apparatus for die cutting web material into shaped articles, and more particularly to an apparatus that precisely aligns a flexible cutting die relative to a rotary cylinder and further aligns the cylinder to the web material to thereby facilitate precise cuts. The present system includes a cylinder for retaining flexible dies, flexible dies, novel attachment mechanisms for retaining the flexible dies on cylinders, and method of attaching a flexible die to a cylinder.

Briefly, to achieve the desired objects of the instant invention, and in accordance with a preferred embodiment thereof, disclosed herein is a method and apparatus to cut web material, the apparatus including a rotary cylinder for use with a flexible die.

In a preferred embodiment of the present invention, the apparatus includes a rotary cylinder having mechanical attachment means for retaining a flexible cutting die, centering and alignment means to precisely place the cutting tool relative the web material, and pressure adjustment means to vary the die cutting depth. The apparatus further includes an anvil roller in cooperating rotational movement with the rotary cylinder, manual drive means, and an infeed tray to support incoming web material.

The preferred web material to be used in accordance with the present invention is preferably sheet material that may be individually fed into the apparatus. Examples of such web materials may include, but are not limited to blank or printed matter such as labels, gaskets, seals, films, cardboard, fabrics, and other sheet goods. The apparatus may also be used to die cut laminated web material. Alternatively the web material may be a continuously spooled sheet of a suitable label material that may be carried on a releasable liner material, and having a first side and a second side. The web material may be preprinted or may contain no printing, and supplied in a spindled roll, or may be supplied as individual sheets.

A method according to the present invention preferably includes the steps of providing a sheet of web material having a first, preprinted side and an oppositely disposed second side along a web material path. Next, a rotary cylinder is provided having a first end surface, a second end surface, and a circumferential surface with at least one mechanical attachment mechanism. A flexible cutting die having at least one cutting blade is provided, the cutting blade corresponding to a predetermined die cutting configuration. The flexible cutting die is further provided with at least one attachment aperture. The flexible cutting die is attached to the circumferential surface of the cylinder through engagement of the mechanical attachment mechanism with attachment aperture. Once affixed to the cylinder, the cutting blade extends radially from the circumferential surface of the cylinder to a predetermined height. The rotary cylinder operates in cooperating rotational movement with an anvil roller. The web material is then moved toward a nip between the rotary cylinder and anvil roller whereby a predetermined die cutting configuration is cut in the web material. An adjustment mechanism may be provided to register the placement of the cutting blade to thereby ensure proper placement of the predetermined die cutting configurations.

Additionally, a pressure adjustment mechanism may be provided to provide selected pressure on the web material between the rotary cylinder and anvil roller. The pressure adjustment mechanism allows the user to vary the pressure to thereby cut the web material at various depths, if for example a backing material is used.

### BRIEF DESCRIPTION OF THE DRAWINGS

FIG. 1A is a perspective view of a prior art cylinder for use with prior art flexible dies and showing magnetic circumferential surface.

FIG. 1B is a perspective view of a prior art cylinder with prior art flexible die in place and held in place by magnetic circumferential surface.

FIG. 2 is a perspective view of a cylinder according to the present invention and having a mechanical attachment system.

FIG. 3 is a perspective view showing a flexible die and cylinder according to the present invention and showing a method of attachment.

FIG. 4 is a view similar to that of FIG. 3, but showing a further step in flexible die attachment.

FIG. 5A is an enlarged cross sectional view of the flexible die for use with the present invention and showing an angled end configuration.

FIG. 5B is a view similar to that of FIG. 5A, but showing a smooth end configuration.

FIG. 6 is a perspective view of a cylinder according to the present invention and showing a flexible die in place and retained for cutting.

FIG. 7 is a view similar to that of FIG. 6, but showing a plurality of flexible dies having various widths in place on the cylinder.

FIG. 8A is a cross sectional view of a cylinder according to the present invention and taken along lines 8-8 of FIG. 2.

FIG. 8B is a cross sectional view, similar to that of FIG. 8A and showing an alternative construction.

FIG. 9 is a fragmentary, enlarged cross sectional view taken along lines 9-9 of FIG. 2 and showing a cylinder having mechanical attachment means according to the present invention.

FIG. 10A is a view similar to that of FIG. 9, but showing a flexible die in place and attached to the cylinder by way of mechanical attachment means according to the present invention.

FIG. 10B is a view similar to that of FIG. 10A, but showing an alternative mechanical attachment design.

FIG. 11 is a perspective view of a cylinder having flexible die attachment means according to the present invention, and showing attachment mechanisms for use with both the leading and trailing edges of a flexible die.

FIG. 12 is a front perspective view of a system with the cylinder and flexible die according to the present invention in place for use.

FIG. 13 is a rear perspective view of the system illustrated in FIG. 12, and with the cylinder and flexible die according to the present invention in place for use.

FIG. 14 is a partially exploded view of the system illustrated in FIGS. 12 and 13.

FIGS. 15-17 are front perspective views similar to that of FIG. 12, but showing a method of installing a flexible cutting die on the cylinder.

FIGS. 18-20 are front perspective views similar to that of FIG. 12, but showing a method of using the system, with flexible cutting die installed on the cylinder, to die cut a web of material.

FIG. 21 is a fragmentary cross section taken along lines 21-21 of FIG. 20 and showing the cylinder, pressure adjustment mechanism and hand wheel locking pin.

FIG. 22 is an end view of the cylinder and showing the centering mechanism and hand wheel locking pin.

FIG. 23 is a view similar to that of FIG. 22 and showing initial infeed of a web to be cut.

FIG. 24 is a fragmentary top view of an illustrative web to be cut and showing distance from the edge to the first cut to be made.

FIG. 25 is a view similar to that of FIG. 23 and showing continued infeed and cutting of a web.

FIG. 26 is a view similar to that of FIG. 25 but showing a first step in adjusting cutting blade alignment.

FIGS. 27 and 28 are views similar to that of FIG. 26 and showing continued steps in adjusting cutting blade alignment.

FIG. 29 is a view similar to that of FIGS. 26-28 but showing cutting of a web by the aligned blade.

FIG. 30 is a fragmentary top view similar to that of FIG. 24 but showing a web having smaller distance from the edge to the first cut to be made.

FIGS. 31 and 32 are end views of the cylinder but with the hand wheel removed for viewing, and showing the pressure adjustment mechanism and use thereof.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention.

The present invention is directed to an improved rotary cylinder having a mechanical attachment mechanism to retain a flexible cutting die thereto. The invention is further directed to a method of attaching a flexible cutting die to the improved rotary cylinder. A method and system for using the improved rotary cylinder and flexible die combination is further contemplated.

Turning now to the drawings, in which like reference numerals refer to corresponding elements throughout the views, attention is first directed to FIGS. 1A and 1B which illustrate perspective views of a prior art rotary cylinder 1 for use with a standard flexible cutting die 2 (see FIG. 1B). As may be viewed particularly in FIG. 1A, the circumferential surface of the cylinder includes a plurality of magnets covering substantially the entire circumferential surface. The magnets 3 provide the sole attachment means for the flexible cutting die 2.

With attention now to FIG. 2, a rotary cylinder 10 according to the present invention and for use with the present system and method may be seen. As may be viewed, the cylinder 10 comprises a generally cylindrically shaped support that serves as a flexible die-bearing circumferential surface. The cylinder 10 is further provided with two oppositely disposed, axially-extending support journals 11. The journals 11 serve to support the cylinder 10 for rotation. The cylinder 10 may be formed by conventional techniques using conventional materials, for example, machined metal. The cylinder 10 further includes a plurality of mechanical attachment mechanisms 12, which may be axially aligned as shown, to secure and align a flexible die 14 (see FIG. 3) on the circumferential surface 15, as will be discussed. The mechanical attachment mechanisms 12 each include a screw 34 having a head portion 16 surrounded by a recess portion 18 (see also FIG. 9). The recess portion 18 may include a magnet 20, although it is within the scope of this invention to include a recess 18 without a magnet 20. As is further seen FIG. 2, the cylinder 10 may also include at least one magnet 20 adjacent the mechanical attachment mechanisms 12. While the view of FIG. 2 illustrates a row of magnets 20, other magnet 20 arrangements may be envisioned within the scope the present invention. Furthermore, the invention may be practiced without the use of magnets 20, as will be discussed with reference to FIG. 11.

With reference now to FIG. 3, a flexible die 14 for use with the present cylinder 10 is illustrated. As shown, the flexible die 14 includes a leading end 28 and a trailing end 30, with at least one of the ends 28, 30 having a plurality of apertures 32 therein. The apertures 32 are adapted to be received by the attachment mechanisms 12, as will be discussed, while at least one of the ends 28, 30 may be secured by magnets 20 (see FIG. 4). The flexible cutting die 14 is further provided with at least one cutting blade 22 having a predetermined die cutting configuration.

The view of FIG. 4 illustrates a cylinder 10 having mechanical attachment mechanisms 12 for retaining the leading end 28 and also a row of magnets 20 for securing the trailing end 30 of the flexible die 14 to the circumferential surface 15. While magnets 20 may be used with the present invention, they are not required. For example, FIG. 11 illustrates an alternative embodiment cylinder 100 having two rows of mechanical attachment mechanisms 12. The alternative cylinder 100 receives a flexible die having apertures 32 on both the leading end 28 and the trailing end 30, such that each of the ends 28, 30 may be fastened to a respective mechanical attachment 12 row. This arrangement may reduce or eliminate the need for magnets 20 and allows the cylinder 100 to be operated without regard to rotational direction, since the flexible die 14 is secured at both ends 28, 30.

As has been described, the trailing end 30 of the die 14 may be held in place by magnets 20 (see FIG. 4) by mechanical attachment mechanism 12 (see FIG. 11), or any combination thereof. Further, and as may be viewed in FIGS. 5A and 5B, the trailing end 30 may have various configurations, such as the smoothly curved arrangement shown in FIG. 5B or the angled configuration seen in FIG. 5A. The angled shape of FIG. 5A urges the trailing end 30 into flat engagement with the magnets 20, when used, and reduces the possibility of the trailing end 30 coming loose during use. Further, it is to be understood that although the flexible die 14 illustrated herein is a cutting die 14, the present invention contemplates other flexible dies, such as those used for printing or embossing, by way of non-limiting example.

The use of mechanical attachment mechanisms 12 to align and secure flexible cutting dies 14 on the cylinder 10 enables the user to utilize flexible dies 14 of various widths without the need for a specialized cylinder 10 each time a new flexible die 14 is required. FIGS. 6 and 7 illustrate various flexible die 14 arrangements that may be used with the present cylinder 10 and system 40. Particularly, the cylinder 10 and system may be used with a single die 14 in place, as shown in FIG. 6, or may be used with multiple dies 14, such as the three shown in FIG. 7. The ability to use multiple or single dies 14 increases the utility of the cylinder 10 since it allows the user to fit the cylinder 10 with dies 14 according to desired use without the need for additional cylinders 10 having the precise width of a die 14, as is required in known arrangements.

FIGS. 8A and 8B depict alternative cross sectional views showing construction of the cylinder 10 shown in FIG. 2. These views illustrate the construction of a cylinder 10 according to the present invention. As seen, the cylinder 10 may include a hollow tube 21, end plates 24 having axially-extending support journals 11, and through bolts 26 to secure the end plates 24 to the tube 21. The tube 21 may be fabricated of a lightweight aluminum or other such material. The use of aluminum reduces the weight and cost of the cylinder 10 as compared to known, heavy steel cylinders having magnetic surfaces, such as the prior art device illustrated in FIG. 1.

An illustrative attachment mechanism 12 for use with the cylinder 10 in the disclosed system 40 may be best seen in the enlarged views of FIGS. 9 and 10A. The attachment mechanism 12 is seen to include a screw 34 having a head portion 16 and a stem portion 36. The attachment mechanism 12 further includes a spacer washer 38. The screw 34 is attached to the cylinder 10 with the head portion 16 extending from the stem portion 36 and situated in a recess 18 in the cylinder outer surface 15. The height of the head portion 16 may be adjusted by way of the spacer washer 38 so that the head portion 16 easily engages the apertures 32 in the flexible die 14, yet remains below the pitch line 42 to ensure proper clearance while in use. The flexible die 14 is arranged such that the apertures 32 receive the head portion 16 of the screw 34 (see FIG. 3). After each aperture 32 is secured to a respective head portion 16, the die 14 is wrapped around the cylinder 10, as will be discussed with reference to FIGS. 15 and 16.

FIG. 10B illustrates an alternative configuration for the attachment mechanism 12. As shown, the head portion 16A illustrated in FIG. 10B is shaped to abut the surface 15. The flattened head portion 16A reduces or eliminates the need for a spacer washer 38.

With attention now to FIGS. 12, 13, and 14, a system 40 including the described cylinder 10 flexible die 14 in working position may be seen. As is shown, the system 40 includes a rotary cylinder 10 having mechanical attachment means (not seen in these views) for retaining a flexible cutting die 14, centering and alignment means 42 to precisely position the flexible cutting die 14 and cutting blade 22 relative the web material 44, and pressure adjustment mechanism, such as a pressure adjustment screw 46 to vary the cutting blade 22 cutting depth, as will be discussed. The system 40 further includes an anvil roller 48 in cooperating rotational movement with the rotary cylinder 10 (see FIG. 14), manual drive means, such as the hand wheel 50 and hand crank 52 seen here, and an infeed tray 54 to support incoming web material 44.

With specific attention to FIG. 14 the various components of the system 40 may be seen. As shown, the system 40 includes a cylinder 10 and an anvil roller 48 in cooperating rotational movement with the cylinder 10. The rotary cylinder 10 and the anvil roller 48 being in rotational contact to provide a nip 56 to receive web material 44. The rotary cylinder 10 and anvil roller 48 rotate in opposite directions such that the web material 44 is drawn into the nip 56 upon contact with the rotary cylinder 10. Preferably, the rotary cylinder 10 is configured such that the height of the flexible die cutting blade 22 is substantially the height needed to cut the web material 44, although it is to be understood that the cylinder 10 may be adjusted to any predetermined pressure necessary to cut through a web material 44 or through a web material 44 without cutting a releasable liner material, if used, as may be required by the user. Pressure may be adjusted by way of the pressure adjustment mechanism, seen as a pressure adjustment screw 46 in this view (see also FIGS. 21, 31, and 32).

The rotary cylinder 10 is also further provided with a manual drive means such as the hand crank 52 and hand wheel 50 shown. A gear block 58 houses the gears 60 for interfacing with the hand crank 52 and cylinder 10. A hand wheel locking pin 62 is provided to align the cylinder 10 and hand wheel 50 to top dead center to thereby ensure proper placement of the predetermined die cutting configurations, as will be discussed with reference to FIGS. 22-30.

A method of securing a flexible cutting die 14 to the rotary cylinder 10 may be seen in the views of FIGS. 15-17. As is shown, the apertures 32 (see particularly FIG. 3) on a leading end 28 of the flexible die 14 are secured to the fastener mechanisms 12 located on the rotary cylinder 10. The hand crank 52 is rotated in the direction of arrow A, which in turn rotates the cylinder 10 in the direction of arrow B. Continued rotation of the hand crank 52 and cylinder 10, with the flexible die 14 secured, positions the flexible die 14 about the circumferential surface 15 of the cylinder 10 until a trailing end 30 of the flexible die 14 meets the leading end 28 and is secured on the cylinder 10 by the magnets 20 shown. Alternatively, and if the cylinder 10 illustrated in FIG. 11 is used, the trailing end 30 of the flexible die 14 may be secured by fastener mechanisms 12 rather than magnets 20.

A method of cutting a web 44 is illustrated in the views of FIGS. 18-20. A web material 44 having a first preprinted side 64 is provided to the system 40 on an infeed tray 54 or similar device. Next, a rotary cylinder 10 is provided. The cylinder 10 includes a circumferential surface 15, having a flexible cutting die 14 attached thereto. The flexible cutting die 14 is provided with at least one cutting blade 22 corresponding to a predetermined die cut configuration. The rotary cylinder 10 operates in cooperating rotational movement with an anvil roller 48. The web material 44 is then moved in the direction of arrow C (see FIG. 19) toward a nip 56 (see FIG. 21) between the rotary cylinder 10 and anvil roller 48. As the hand crank 52 is rotated in the direction of arrow D, a die cutting configuration is cut in the web material 44. The cylinder 10 is provided with manual drive means, such as the hand crank 52 and hand wheel 50 shown. The hand crank 52 interfaces with the cylinder 10 via the gears 60 shown in FIGS. 14 and 21, although it is within the scope of the present invention to use other means, such as but not limited to, belts, shafts, or the like. The gears 60 drive the cylinder 10 by engaging the journal 11 which is supported in a bearing block 66 containing bearings 68. The bearing block is further supported by housing 76 (see FIGS. 14 and 21).

The present system 40 is further provided with means to adjust registration of the cutting die 14. For example, webs 44 to be used with the present invention may vary in preferred placement of the cuts. As may be compared in the views of FIGS. 24 and 30, a web 44 may have a first distance d from the top of the web 44 to the die cut 70, while another web 44 may have a second distance d′ from the top of the web to the die cut 70. To ensure proper registration of the die cut 70, the present invention contemplates use of a registration adjustment mechanism in the form of a hand wheel locking pin 62. FIGS. 22-30 illustrate the components and method of the registration adjustment mechanism.

With attention to FIG. 22, a side view of the cylinder 10, anvil roller 48, hand wheel 50, and hand wheel locking pin 62 may be seen. The hand wheel pin 62 aligns the cylinder 10 and hand wheel 50 to top dead center. In this view, the cutting blade 22 is registered to a position located at a first predetermined angle a relative to the web 44. FIG. 23 illustrates operation of the system 40 while the cylinder 10 is registered as shown in FIG. 22. The web 44 illustrated in FIG. 24 shows the distance d required for spacing of the first cut relative the top of the web 44 as is registered in FIG. 22. Each subsequent web 44 material having distance D is moved through the system 40 as is shown in FIG. 25 as the hand crank 52 is moved in the direction of arrow E, and the cylinder 10 is moved in the direction of arrow F. The web 44 moves through the nip 56 in the direction of arrow G. Should registration adjustment of the cylinder 10 be desired, the adjustment bolt 74 is loosened in the direction of arrow H (see FIG. 26). Loosening of the adjustment bolt 74 permits the hand wheel 50 to be rotated independently of the cylinder 10, for example, in the direction of arrow J (see FIG. 27). After the hand wheel 50 is rotated to a selected position, the adjustment bolt 74 is tightened, and the cylinder 10 moved to top dead center in the direction of arrow K, by use of the locking pin 62. The indicator pin 72 aids the user to visualize the new angle a′ to verify accurate registration. After registration, and as seen in FIG. 29, the locking pin 62 is released and the apparatus may be used in the manner previously described to cut web 44 having a different top edge to cut 70 distance, such as d′ shown in FIG. 30.

As previously mentioned, the apparatus 10 may be used to die cut various web 44, including pressure sensitive web, such as those having a backing layer (not shown). When a backing layer is used, it may be desired to cut through a portion of the web 44, while leaving the backing intact. To accomplish this purpose, the system 40 may be provided with a pressure adjustment mechanism to vary the pressure exerted by the cylinder 10 against the anvil roller 48, and therefore the depth of the cuts made by the flexible cutting die 14. FIGS. 31 and 32 illustrate a pressure adjustment mechanism for use with the present apparatus. As seen, a pressure adjustment screw 46 may be rotated to exert downward pressure on the bearing block 66. Increased downward pressure on the bearing block 66 urges the cylinder 10 against the anvil roller 48 thereby creating greater pressure in the nip 56. As a web 44 moves though the nip 56 this greater pressure results in a greater depth of cut.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. An apparatus for die cutting comprising:
a rotary cylinder having a circumferential surface, at least one mechanical attachment mechanism located on said circumferential surface;
a flexible cutting die, said flexible cutting die including at least one cutting blade extending therefrom, said at least one cutting blade corresponding to a predetermined die cutting configuration; and
an anvil roller disposed in cooperating rotational movement with the rotary cylinder to provide a nip, the nip being positioned for receiving a web material, whereby the web material is die cut in the predetermined die cutting configuration.

2. The apparatus of claim 1 wherein said flexible cutting die includes a first end and a second end.

3. The apparatus of claim 2 wherein at least one of said first end and said second end includes an at least one aperture therein.

4. The apparatus of claim 1 wherein the web material includes a releasable liner material.

5. The apparatus of claim 4 further including a cutting blade pressure adjustment mechanism.

6. The apparatus of claim 1 further including drive means, the drive means communicating with the anvil roller and the rotary cylinder.

7. The apparatus of claim 6 wherein said drive means is manually operable.

8. The apparatus of claim 3 wherein said circumferential surface includes at least one recess, said at least one mechanical attachment mechanism being located in said at least one recess.

9. The apparatus of claim 8 wherein said mechanical attachment mechanism includes a screw member having a stem portion and an extending head portion.

10. The apparatus of claim 9 wherein said head portion is engagable with said aperture.

11. The attachment mechanism of claim 8 further including a spacer washer.

12. The apparatus of claim 3 further including a cutting blade registration mechanism.

13. A method of die cutting, the method comprising the steps of:
providing a web material;
providing a rotary cylinder having a circumferential surface, the circumferential surface being provided with at least one mechanical attachment mechanism;
providing an anvil roller, said cylinder and said anvil roller cooperating to form a nip therebetween;
providing a flexible cutting die having a first end and a second end, at least one of said first and second ends having an aperture therein;
providing said flexible die with at least one cutting blade thereon;
engaging said aperture with said mechanical attachment mechanism;
positioning said flexible die on said circumferential surface;
moving said web material into said nip;
rotating said cylinder and attached flexible die; and
cutting said web material with said cutting blade.

14. The method of claim 13 further including the step of providing said first end and said second end of said flexible die with at least one aperture.

15. A method of die cutting a web including the steps of:
providing a sheet of web material having a first, preprinted side;
moving said sheet along a web material path;
providing a rotary cylinder, said cylinder having a first end surface, a second end surface, and a circumferential surface, said circumferential surface being provided with at least one mechanical attachment mechanism;
providing a flexible cutting die having at least one cutting blade, the cutting blade corresponding to a predetermined die cutting configuration;
providing said flexible cutting die with at least one attachment aperture;
engaging said mechanical attachment mechanism with said attachment aperture to attach said flexible cutting die to the circumferential surface of the cylinder;
providing an anvil roller in cooperating rotational movement with said rotary cylinder;
providing a nip between said rotary cylinder and said anvil roller;
moving said web material toward a nip whereby a predetermined die cutting configuration is cut in the web material.
